(19) United States
(12) Patent Application Publication
(10) Pub. No.: US 2012/0073608 A1
(43) Pub. Date: Mar. 29, 2012

(54) DISHWASHER COMPRISING A HEAT EXCHANGER AND CORRESPONDING CONTROL METHOD

(75) Inventors: Roland Rieger, Rainau (DE); Michael Georg Rosenbauer, Reimlingen (DE)

(73) Assignee: BSH BOSCH UND SIEMENS HAUSGERÄTE GMBH, Munich (DE)

(21) Appl. No.: 13/322,927

(22) PCT Filed: Jun. 1, 2010
(86) PCT No.: PCT/EP10/57607

§ 371 Date: Nov. 29, 2011

(30) Foreign Application Priority Data
Jun. 10, 2009 (DE) 10 2009 026 876.6

(51) Int. Cl. A47L 15/14; B08B 3/04

(52) U.S. Cl. 134/25.2; 134/105

(57) ABSTRACT

A dishwasher includes a wash cavity for accommodating wash items and a water inlet device having a hot water inlet for intake of hot water from an external hot water supply, and a cold water inlet for intake of cold water from an external cold water supply. At least one reservoir is in communication with the water inlet device for allowing water to be filled by the water inlet device and in heat-conducting contact with the wash cavity. At least one wash program for controlling at least one wash cycle for cleaning wash items is stored by a program control device, with the wash program providing at least one program step for washing wash items using hot water from the hot water supply and at least one drying step for drying wash items, wherein the reservoir is filled at least at times with cold water from the cold water supply.

The present invention relates to a dishwasher, particularly a domestic dishwasher, comprising a wash cavity for accommodating wash items, a water inlet device for the intake of water from at least one external water supply, at least one reservoir which can be filled with water by the water inlet device and is in heat-conducting contact with the wash cavity, and comprising a program control device in which at least one wash program for controlling at least one wash cycle for cleaning wash items is stored.

In modern dishwashers, the wash items, in particular wash items to be washed, are placed in a wash cavity and cleaned therein in a washing process, also designated a wash cycle, with the aid of water, and are subsequently dried. The aim therein is to carry out a wash cycle such that a pre-defined cleaning result and a pre-defined drying result are achieved as efficiently as possible. A high degree of overall efficiency resulting from the cleaning efficiency and the drying efficiency is required. The cleaning efficiency corresponds to the ratio of the cleaning result achieved by means of a wash cycle to the effort required therefor, wherein the effort can involve multiple dimensions, such as energy usage, water usage and/or the time taken. Furthermore, the drying efficiency corresponds to the ratio of the drying result achieved by means a wash cycle to the effort required therefor, wherein here also the effort can involve multiple dimensions, such as the energy usage and/or the time taken.

In modern dishwashers a program control device is normally provided which automatically controls a wash cycle which is usually selectable. The water required for performing wash cycles in known dishwashers can be fed in via a water inlet device which can take in water, for example, from a water supply installed in a building.

A wash program has a plurality of program steps in sequence for treating the wash items, the water being provided, in the program steps using water, with cleaning and/or additive substances depending on the respective program step and brought to a temperature suitable for the respective program step. In order to be able to provide the water for washing with the cleaning, rinse aid and/or additive substances provided, modern dishwashers usually have automatic dosing devices. Dishwashers can also usually comprise an electrical heating device to bring the water provided for washing to the required temperatures.

For cleaning the wash items, a typical wash program comprises, in the following chronological order, in particular, a pre-wash step, a cleaning step, an intermediate rinsing step, and a final rinsing step, in each of which water is applied to the wash items. However, wash programs can also be provided in which one or more of said program steps are omitted. For example, the intermediate rinsing step can be omitted. Wash programs can also be provided wherein one or more of said program steps are run through multiple times. Furthermore, a typical wash program comprises a final drying step in order to dry the cleaned wash items.

A pre-wash step serves primarily to remove heavier soiling from the wash items. The purpose of a subsequent cleaning step is, in particular, the complete removal of dirt from the wash items. An intermediate rinsing step performed thereafter serves, in particular, to remove cleaning agent residues adhering to the wash items. A subsequent final rinsing step is provided, in particular, to prevent flecks that can occur on the wash items due to dissolved substances in the water, such as salt and/or lime. For this purpose, rinse aid is added to the water during the final rinsing step. Another purpose of the final rinsing step lies in preparing for the subsequent drying step. For this, the wash items are heated to a high temperature during the final rinsing step. In the subsequent drying step, water drops adhering to the hot wash items evaporate and condense on the inside of the wash cavity due to the lower temperature prevailing thereon.

Known dishwashers have a reservoir which can be filled with water by the water inlet device and is in heat-conducting contact with the wash cavity and is known in the art as a “heat-exchanger”. Said reservoir is filled with water during the drying step, in order to cool at least part of the wall of the wash cavity of the dishwasher. In this way, the condensation of steam on the inside of the wash cavity and consequently the tendency toward evaporation of water droplets adhering to the wash items is increased so that the drying result is significantly improved for the same input of time and energy. Furthermore, in many cases, the temperature to which the wash items are heated during the final rinsing step can therefore be selected to be lower. In this way, a better drying efficiency is achieved compared with a dishwasher without a reservoir.

Against the background of increased energy and water costs, but also in the context of increasing environmental awareness and changing life habits among large parts of the population, a need for more efficient domestic dishwashers has developed.

A disadvantage of the known dishwashers equipped with a reservoir is that such machines no longer meet current needs for efficiency.

An object of the present invention is to provide a dishwasher equipped with a reservoir which enables efficient performance of wash cycles.

This object is achieved in a dishwasher of the aforementioned type in that the water inlet device has a hot water inlet and a cold water inlet, the hot water inlet being configured for the intake of hot water from an external hot water supply and the cold water inlet being configured for the intake of cold water from an external cold water supply, and the wash program providing at least one program step for washing wash items using hot water from the hot water supply and at least one drying step for drying wash items, wherein the reservoir is filled at least at times with cold water from the cold water supply.

Dishwashers, in particular domestic dishwashers, are usually operated at sites where a hot water supply and a cold water supply are available. The temperature of the hot water of typical permanently installed hot water supplies can lie, for example, in the range of approximately 40° C. to 70° C. By contrast, the temperature of the cold water of typical permanently installed cold water supplies lies preferably in the range of approximately 5° C. to 15° C.

A water inlet device having a hot water inlet and a cold water inlet makes it possible to carry out a wash cycle for cleaning and/or drying wash items more efficiently. Thus, wash programs for controlling a wash cycle are presently possible which provide for the performance of individual program steps using hot water from an external hot water supply and the performance of other program steps using cold water from an external cold water supply. In this way, compared both with known dishwashers which—as is usual above all in Europe—are provided only for connection to a cold water supply, and with known dishwashers which—as is usual above all in North America—are provided only for connection to a hot water supply, a significant efficiency enhancement can be achieved.

Insofar as a program step of a selected running dishwashing program requires or at least makes desirable, based on the nature of said program, the use of water at a higher temperature, hot water can be drawn from an external water supply for said program step. The intake of the hot water can take place before or during the respective program step.

The intake of hot water for a program step of this type is, in many cases, more energy-efficient and cost-efficient than the intake of cold water. The reason for the improved cost efficiency lies therein that, on intake of hot water, the internal electrical energy requirement of the dishwasher for a wash cycle is significantly reduced due to the lower electrical energy requirement for heating the water taken in. This can lead to a significant lessening of the power costs of the household. This saving is greater, in many cases, than the additional cost for creating the hot water in the external hot water supply. In this way, an efficiency increase can be achieved as compared with a dishwasher which is provided for connection exclusively to a cold water supply.

This applies in particular if a modern condensing boiler system, a cogeneration system a district heating system or local heating system is available to the household for hot water supply. And the cost advantage can be further increased if the household has access to a geothermal heat pump or, in particular, a solar energy installation for producing the hot water.

Furthermore, for a program step in which the use of water at a higher temperature brings no advantages or is even disadvantageous, cold water can be drawn from the external cold water supply. Here also, the intake of cold water can occur before or during the respective program step.

In contrast to a dishwasher provided exclusively for connection to a hot water supply, disadvantages associated with dishwashing technology and resulting from the compulsory use of hot water in special program steps can thus be avoided. Furthermore, through the partial intake of cold water from the external cold water supply, the quantity of hot water that must be drawn from the external hot water supply for a wash cycle can be reduced without substantial disadvantages having to be accepted in relation to the cleaning effect and/or the drying effect achieved. It is thus ensured that the ratio of the saving of electrical energy for the operation of an electrical heating device of the dishwasher to the additional cost for providing a sufficient quantity of hot water by means of the external hot water supply is a favorable one.

The dishwasher according to the invention realizes the stated advantages in that stored in the program control device is at least one wash program which provides at least one program step for washing wash items using hot water from the hot water supply and at least one program step for drying wash items, the reservoir being filled at least temporarily with cold water from the cold water supply.

In a program step for the washing of wash items, the achievable cleaning effect depends, in particular, on the temperature of the water used for washing. In many cases, it is therefore desirable or even necessary to use water that has a higher temperature than water from a conventional cold water supply. Therefore, by using hot water in a program step of this type, a significant quantity of energy that would have to be expended if using cold water, for the heating thereof, can be saved.

Moreover, due to the fact that the reservoir is filled, at least temporarily, with cold water from the cold water supply during the drying step, particularly strong cooling of at least part of the wall of the wash cavity of the dishwasher is caused, so that the condensation of steam is promoted all the more. In this way, the tendency of water drops adhering to the wash items to evaporate is particularly strongly enhanced, so that the drying effect is significantly improved compared with dishwashers which are connected exclusively to a hot water supply and wherein the reservoir consequently has to be filled with hot water. The intended drying effect can thus be achieved in a significantly shorter time. This enhances the efficiency substantially. Furthermore, compared with conventional dishwashers in which the reservoir is fillable only with hot water during the drying step, a smaller demand is placed on the external hot water supply. In this way, an increase in the overall efficiency of a wash cycle carried out by means of a dishwasher according to the invention is achieved.

According to a preferred development of the invention, the wash program provides a cleaning step for washing wash items wherein hot water from the hot water supply is applied to the wash items. A cleaning step serves for thorough cleaning of the wash items. For this purpose, it is necessary to apply water at a relatively high temperature to the wash items, in order to achieve a high thermal cleaning effect. In general, cleaning agent is added to the water, the chemical cleaning effect thereof being best at higher temperatures. Normally, therefore, a temperature in the range of approximately 50° C. to 70° C. is provided for a cleaning step. Where hot water from the hot water supply is used for the cleaning step, it is also ensured that the heat energy drawn from the hot water supply is usefully employed. It is precisely in this way that a large electrical energy saving can be achieved, since in many cases, the hot water from the hot water supply does not require any further heating by the electrical heating system of the dishwasher and, in other cases, only to a small extent in order to reach the required minimum temperature for the cleaning step.

According to an advantageous development of the invention, the wash program provides a final rinse step for rinsing the wash items, particularly following a cleaning step or possibly after an intermediate rinsing step in which hot water from the hot water supply is applied to the wash items. A final rinse step serves, particularly, to prevent flecks on the wash items which can arise due to dissolved substances in the water, such as salt and/or lime. For this purpose, rinse aid is added to the water during the final rinsing step. A further object of the final rinsing step lies in preparing for a subsequent drying step. Thus, during the final rinsing, the wash items are heated, particularly using hot water, for example, at a temperature in the range of 60° C. to 75° C. In the subsequent drying step, water drops adhering to the hot wash items evaporate and condense on the inside of the wash cavity due to the lower temperature prevailing thereat. By this means, in conjunction with the reservoir which is filled with cold water from the cold water supply and cools at least part of the interior of the wash cavity, an excellent drying result is achieved in an extremely short time. Where hot water from the hot water supply is used for the final rinsing step, it is also ensured that the heat energy drawn from the hot water supply is usefully employed. In this case, again, a large saving of electrical energy can be achieved since, in many cases, the hot water from the hot water supply does not need to be further heated at all by the electrical heating system of the dishwasher and, in other cases, only slightly, in order to achieve the minimum temperature required for the final rinsing step.

According to an advantageous development of the invention, the wash program possibly provides an intermediate rinsing step, particularly between the cleaning step and the final rinsing step for cleaning wash items, wherein in order to remove cleaning agent from the wash items following a cleaning step, cold water from the cold water supply is applied to the wash items. An intermediate rinsing step serves, in particular, to remove cleaning agent residues adhering to the wash items following a cleaning step. Again, the desired effect of the intermediate rinsing step can be achieved in a relatively short time if water at a relatively high temperature is used. By using hot water from the external hot water supply, the electrical energy requirement of the dishwasher can be further reduced.

According to an advantageous development of the invention, the wash program provides at least one program step for washing wash items, particularly a pre-wash step and/or a cleaning step, wherein cold water from the cold water supply, with which the reservoir was filled during a drying step of a previous wash cycle, is applied to the wash items. By storing the water during a drying step of a first wash cycle for a program step of a subsequent wash cycle, the water usage for said wash cycle can firstly be reduced. Furthermore, the cold water can become warmed during storage thereof to the ambient temperature which, in a household, is typically between 5° C. and 10° C. higher than the temperature of the cold water when drawn from the cold water supply. Thus, preheated water is available to a certain extent for a program step of the later performed wash cycle, without loading the hot water supply. This further increases the overall efficiency of the dishwasher.

According to an advantageous development of the invention, the wash program provides at least one program step for washing wash items, particularly a pre-wash step, a cleaning step, an intermediate rinsing step and/or a final rinsing step, wherein hot water from the hot water supply, with which the reservoir was filled during a previous program step of the same wash cycle, is applied to the wash items. In this way, in many cases, the temperature of the hot water can be increased before being applied to the wash items. This procedure is particularly worthwhile if the temperature of the hot water supply is relatively low, for example, between 40° C. and 50° C., and the water in the wash cavity is heated by means of the heating device of the dishwasher to a higher temperature, for example, 60° C. or even 70° C. In this way, recovery of heat energy from the water in the wash cavity before said water is pumped out is possible, thereby increasing the efficiency.

According to a particularly preferable development of the invention, the wash program provides for filling of the reservoir with cold water from the cold water supply, particularly after ending the final rinsing step of the wash program, at the start of, and/or during, the drying step of the respectively running wash program. A drying step of a wash program usually follows directly after a final rinsing step. Whereas during performance of the final rinsing cycle, relatively hot water is circulated in the wash cavity, during the drying step, no circulation of water takes place. Rather, at the start of the drying step or shortly thereafter, the water collected in a lower region of the wash cavity is pumped out of the dishwasher. If, as intended, the reservoir is only filled with cold water at the start of, or during, the drying cycle and not before, the water in the reservoir is prevented from being heated by the hot water of the final rinsing step.

According to a preferred embodiment of the dishwasher according to the invention, the program control device is configured to adapt a wash program in the event of the connection between the hot water inlet and the hot water supply or the connection between the cold water inlet and the cold water supply being lacking. For this purpose, sensors can be provided by means of which the program control system recognizes whether the hot water inlet or the cold water inlet is connected to a hot water supply or not. The sensors can be, in particular, flow sensors or pressure sensors. Temperature sensors are also conceivable, so that it can be detected whether the respective water inlet device is connected to a cold water supply or a hot water supply. The adaptation of the wash program can be carried out, for example, in that if no hot water supply is connected, hot water is replaced with cold water which is then heated as much as needed in the wash cavity. Given the lack of a cold water supply, the step “fill the reservoir with water during the drying step” can be omitted.

According to a further embodiment of the invention, the reservoir lies flat against the wash cavity. In this way, good heat transmission from the wash cavity to the reservoir is possible. Complex heat conducting components are not needed. A substantial improvement in the drying result of the dishwasher is thus achieved with little design effort.

According to an advantageous development of the invention, the reservoir is a plastics element. Containers of this type can be produced, for example, by suitable extrusion or molding processes with little manufacturing effort. Reservoirs made from plastics also have a certain degree of flexibility, so that given suitable fastening, they conform particularly well to the wash cavity especially when filled, and this also improves the drying efficiency.

According to a suitable development of the dishwasher according to the invention, the reservoir is arranged at a side wall, base wall and/or rear wall of the wash cavity. The side wall of a wash cavity is sufficiently stable to support a filled reservoir. By this means, it is possible, particularly given a side wall mounting of the reservoir, to fasten the reservoir directly to the wash cavity, thereby improving the heat transfer from the wash cavity to the reservoir. The side wall of a wash cavity is also configured essentially flat, so that the production of a contact over an area between the reservoir and the wash cavity is easily possible. For example, an easily manufactured cuboid reservoir can be used.

According to an advantageous development of the invention, the reservoir is arranged at an upper section of the wash cavity. Since higher temperatures prevail at an upper region of the wash cavity during the drying process than at a lower region, in this way the condensation of the water vapor in the wash cavity is further improved, thus improving the drying result. In addition, the arrangement at an upper region of the wash cavity enables problem-free emptying of the reservoir by gravity.

According to an advantageous development of the invention, a free flow path is assigned to the hot water inlet device and/or the cold water inlet device. The free flow path or paths can be arranged, for example, in the reservoir. Thanks to the free flow paths, back-suction of water in the direction of the hot water supply or the cold water supply, which could arise due to a temporary negative pressure caused by dynamic processes, is prevented. In this way, in particular, too low a water level in the reservoir and/or in the wash cavity can be prevented.

According to a preferred development of the invention, it is provided that the hot water inlet comprises a hot water valve and the cold water inlet comprises a cold water valve, the hot water valve and the cold water valve being controllable independently of one another by the program control device. It is thus easily possible to perform the intake of hot water from the hot water supply provided for by the wash program and the intake of cold water from the cold water supply provided for by the wash program. In particular, an external apparatus for controlling the water intake can be dispensed with.

According to a suitable development of the invention, it is provided that the hot water valve is arranged and configured at an upstream end of a hot water hose such that said valve can be fastened to a connection member of the external hot water supply, and/or that the cold water valve is arranged and configured at an upstream end of a cold water hose such that said valve can be fastened to a connection member of the external cold water supply. For this purpose, the hot water valve and/or the cold water valve can have, for example, connection threads which correspond to threads of common domestic water taps. Valves of this type can be configured, particularly, as Aquastop valves.

The arrangement of the hot water valve and/or the cold water valve at the upstream end of the water inlet device has the advantage that, even should damage occur, practically no leakage water can emerge from the dishwasher as long as the valves are closed. If the valves are, in particular, configured so as to close when no longer powered, the emergence of leakage water from a dishwasher that has been switched off is prevented in practically all cases. In order also to prevent the emergence of leakage water from a switched-on dishwasher, a leakage water sensor can be assigned to the program control device, for detecting leakage water, so that the program control device can close the valves on appearance of leakage water during operation of the dishwasher.

According to a preferred development of the invention, it is provided that a downstream end of the hot water hose and a downstream end of the cold water hose are linked via a linkage member, preferably a Y-linkage member, in fluid conducting manner, particularly via the outlet-side common inlet hose, to a connection member fixed to the housing of the dishwasher. Such a configuration of the water inlet device is simple in design and significantly shortens the total required hose length in many cases, particularly if the connection sites of the external hot water supply and of the external cold water supply are further from the installation location of the dishwasher, since in such a case, the provision of two relatively long parallel hoses can be dispensed with.

The invention also concerns a method for controlling at least one wash cycle of a dishwasher, in particular a domestic dishwasher by means of at least one wash program of a program control device, wherein the dishwasher comprises a wash cavity for accommodating the wash items, a water inlet device for the intake of water from at least one external water supply and at least one reservoir which can be filled with water from the water inlet device and is in heat-conducting contact with the wash cavity, characterized in that at least one program step is carried out by the wash program for washing wash items, hot water fed from an external hot water supply by a hot water inlet being used and that the wash program performs at least one drying step for drying the wash items, the reservoir being at least temporarily filled with cold water from an external cold water supply by a cold water inlet.

Other advantageous developments of the invention are disclosed in the subclaims.

The invention and its developments will now be described by reference to the drawings, in which:

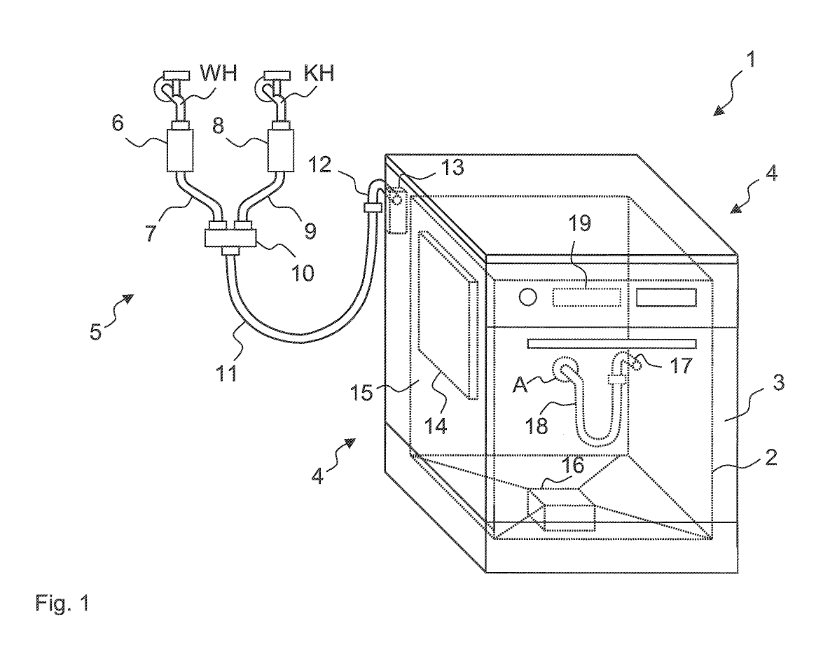

FIG. 1 is a schematic spatial representation of an advantageous exemplary embodiment of a dishwasher according to the invention;

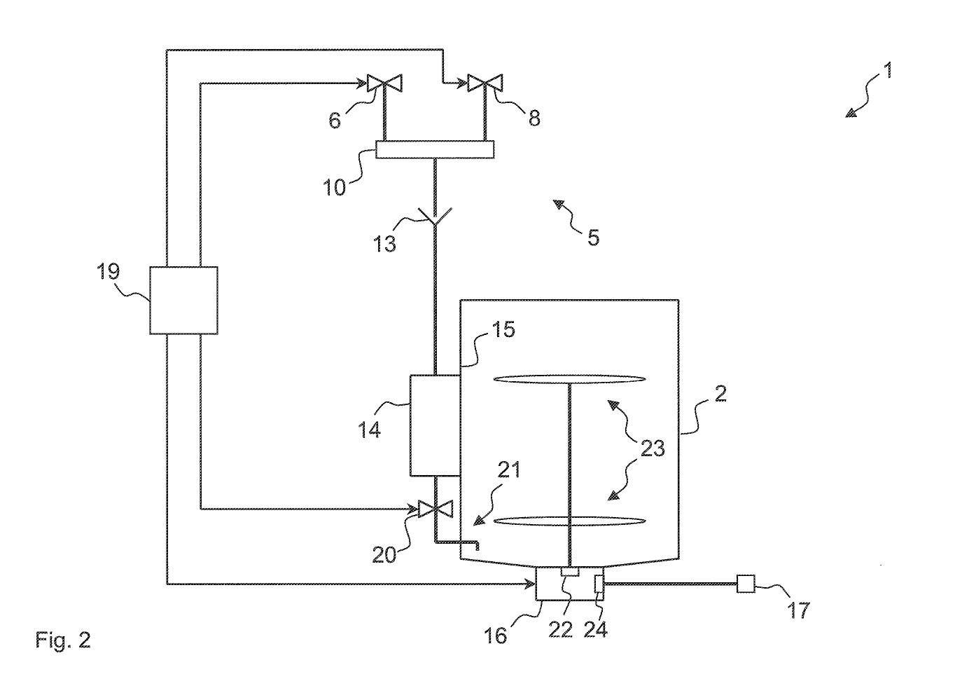

FIG. 2 is a block circuit diagram of the dishwasher of FIG. 1;

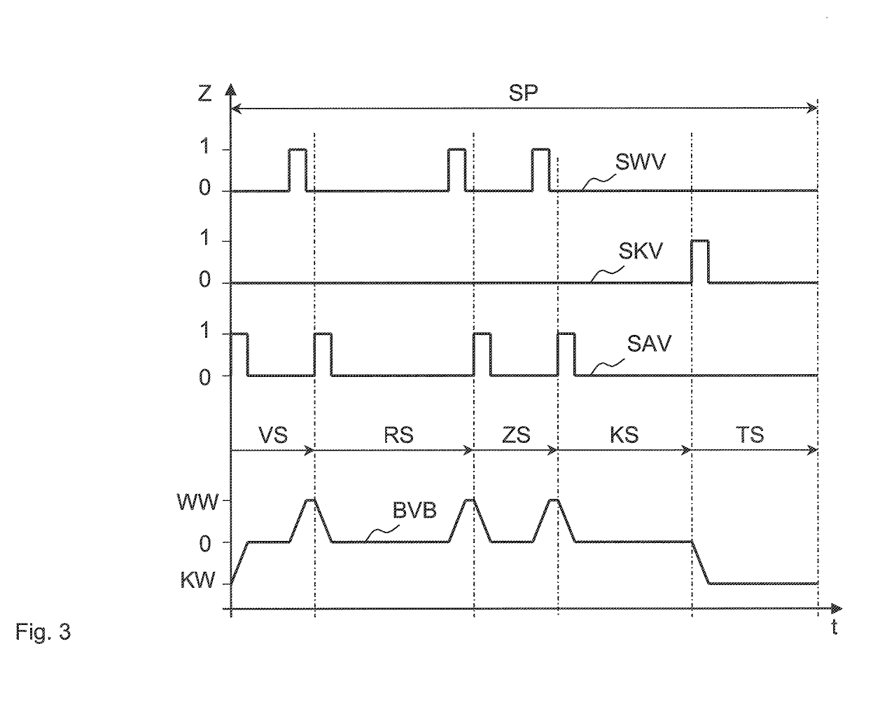

FIG. 3 is a schematic function diagram to explain the function of the dishwasher of FIGS. 1 and 2.

In the following figures, parts which correspond to one another are identified with the same reference number. Only those parts of a dishwasher that are necessary for an understanding of the invention are identified with reference numbers and described. It is self-evident that the dishwasher according to the invention can comprise further parts and assemblies.

FIG. 1 shows a schematic spatial representation of an advantageous exemplary embodiment of a dishwasher 1 according to the invention. Said dishwasher has a wash cavity 2 which is closable with a door 3 so that a wash cell for washing wash items is created. The wash cavity 2 is arranged in the interior of a housing 4 of the dishwasher 1 which has standard dimensions. For example, the housing 4 can have a width of 45 cm or 60 cm, which enables integration of the dishwasher 1 into a standard configuration of kitchen units with a suitable installation niche.

Arranged on the rear side of the dishwasher 1 is a schematically shown water inlet device 5. Said inlet device has a hot water inlet 6, 7 and a cold water inlet 8, 9, the hot water inlet 6, 7 being provided for the intake of hot water from an external hot water supply WH and the cold water inlet 8, 9 being provided for the intake of cold water from an external cold water supply KH.

The hot water inlet 6, 7 comprises a controllable hot water valve 6 and the cold water inlet 8, 9 comprises a controllable cold water valve 8. The hot water valve 6 and the cold water valve 8 are, in principle, identically constructed. For example, both valves 6, 8 can be configured as solenoid valves. The inlet sides of the valves 6, 8 are each configured such that said valves can be attached to connection members of a typical household hot water supply WH and cold water supply KH, for example, to taps (hot water tap and cold water tap). The connection can be made in each case with a screw connector, a snap connector or the like. Valves 6, 8 of this type are also known under the name Aquastop valves 6, 8. Advantageously, said valves are closed when not actuated, so that in the switched-off state, the dishwasher 1 is isolated from the water supply. Thus, in the event of a fault, the emergence of leakage water from the switched-off dishwasher 1 can be prevented.

By design in FIG. 1, the input side of the hot water valve 6 is connected to a hot water tap of the hot water supply WH and the input side of the cold water valve 8 is connected to a cold water tap of the cold water supply KH. The output side of the hot water valve 6 is connected to a hot water hose 7 and the output side of the cold water valve 8 is connected to a cold water hose 9, the downstream ends of the hot water hose 7 and of the cold water hose 9 being connected to the input side of a linkage member 10. Connected to the output side thereof is a common inlet hose 11 for hot water and cold water which, in turn, is connected to a connection member 12 at the housing 4 of the dishwasher 1. It is therefore possible, with the water inlet device 5, to feed hot water from an external hot water supply WH and/or cold water from an external cold water supply KH, each individually controlled, into the interior of the dishwasher 1.

The hot water hose 7, the cold water hose 9 and/or the common inlet hose 11 can be configured as safety hoses with an inner water-carrying pressure hose and an outer jacket hose, wherein a leakage water channel can be provided, in each case, between the pressure hose and the jacket hose to carry away any leakage water. The linkage member 10 can be configured so that the leakage water channels of the hot water hose 7, the cold water hose 9 and the common inlet hose 11 are connected to one another such that leakage water emerging during operation of the dishwasher 1 in the region of the water inlet device 5, is conducted via the connection member 12, fixed to the housing, into the interior of the dishwasher 1. Here the water can be detected by a leakage water sensor (not shown), so that relevant measures such as closing the hot water valve 6 and the cold water valve 8 can be instigated.

As an alternative to said external arrangement of the, particularly Y-shaped, linkage member 10 outside the dishwasher, it may be advantageous if the linkage member is firmly coupled or molded, at the dishwasher, particularly inside the dishwasher, to the connection member accommodated at the dishwasher, particularly without an external inlet hose. Said arrangement can be prepared, particularly, during manufacturing. In this alternative embodiment, the common inlet hose can possibly be dispensed with. In particular, the connection member 12 can be provided with the Y-linkage member in the region of the base assembly of the dishwasher, thereupon or therein.

Provided downstream of the connection member 12 attached to the housing is a free flow path 13. The free flow path 13 is a pipe-interrupter, which serves to prevent back-suction of water from the dishwasher 1 if a negative pressure forms due to dynamic processes in the external water supply. In particular, this prevents already used water which may be laden with dirt, cleaning agents and/or cleaning aids passing back into the building-side water supply.

The dishwasher 1 also comprises a reservoir 14 as a heat exchanger which is connected with means not shown in FIG. 1 to the free flow path 13 so that said reservoir can be filled with cold water from the cold water supply KH and/or with hot water from the hot water supply WH. Said reservoir is arranged at a side wall 15 of the wash cavity 2 such that heat transfer from the wash cavity 2 to the reservoir 14 is possible. The reservoir 14 is configured as a very flat cuboid. Said reservoir is, in particular, configured pocket-shaped or panel-shaped. The width is, for example, approximately 2 cm, so as to be placeable without difficulty between the side wall 15 of the wash cavity 2, particularly between the bitumen coating thereof and a wall of an outer housing of the dishwasher 1. Both the height and depth of the wash cavity can be, for example, between 40 cm and 50 cm. Therefore a reservoir volume of, for example, between 3 l and 4 l can be achieved. This quantity is sufficient in order to carry out a program step for washing wash items, for example, a pre-wash step, a cleaning step, an intermediate rinsing step and/or a final rinsing step, purely with water from the reservoir 14. Due to the flat construction, a large contact area is produced between the wash cavity 2 and the reservoir 14. As a result, a good heat transfer is possible.

Although the wash cavity 2 can be made from stainless steel, the reservoir 14 is preferably made from plastics. The reservoir 14 can, in particular, be made from polypropylene, which is an economical and easily processed plastics material. The reservoir 14 can therefore be made by simple means using extrusion methods or molding methods. Since the side wall 15 of the wash cavity 2 is configured essentially flat, the inwardly facing heat contact surface of the reservoir 14 is made flat and is therefore easily manufactured. In particular, when the reservoir 14 is filled, due to the flexibility of the materials thereof, said reservoir fits particularly well onto the wash container 2, particularly the outer bitumen layer thereof. By this means, the heat transfer is also positively influenced. The bitumen layer in the side wall of the wash cavity has been left out in FIG. 1 for the sake of simplicity.

During a drying step of a wash program of the dishwasher 1, due to the heat-conducting contact between the reservoir 14 and the wash cavity 2, the inside of the side wall 15 of the wash cavity 2 is cooled. In order to maximize this cooling, it is provided that the reservoir 14 is filled during the drying step at least temporarily with cold water from the cold water supply KH. By this means, condensation of water vapor in the wash cavity 2 on the side wall 15 is enhanced. This leads to an improved drying result when the wash program is performed. The reservoir 14 is arranged at an upper section of the wash cavity 2 since higher temperatures usually prevail there than in a lower section, with the result that cooling of the side wall leads here to a particularly good drying effect.

Provided in a lower region of the wash cavity 2 is a pump housing 16 in which, suitably, a circulation pump for circulating water in the wash cavity 2 during a wash cycle is provided. The circulation pump can have a heating device, for example a flow heater, for heating the water situated in the wash cavity 2. A pump for pumping out water, for example, at the end of a wash cycle can also be provided in the pump housing 16. However, the different pumping functions can also be performed by a single pump in conjunction with switchable valves. The pump housing 16 is normally connected to a waste water connection member 17 via means (not shown) such that water can be pumped out of the wash cavity 2 via a waste hose 18 connected to a waste connection member 17 into a waste apparatus A, for example a waste pipe A, installed at the building.

The dishwasher 1 also comprises a program control device 19 for controlling the sequence of a wash program. Various wash programs that are selectable by a user can be stored in the program control device 19. The program control device 19 is arranged in the interior of the door 3 of the wash cavity 2, but could also be arranged at another site of the dishwasher 1.

FIG. 2 shows a schematic block circuit diagram of the dishwasher 1 of FIG. 1. The hot water valve 6 and the cold water valve 8 are each connected to the program control device 19 such that both are individually controllable. It is therefore possible to fill the reservoir 14 via the linkage member 10 and the free flow path 13 specifically with hot water and/or cold water. At the lower end of the reservoir 14, an outlet valve 20 is provided to which an outlet 21 is connected downstream, said outlet opening into the wash cavity 2. The outlet valve 20 is also controllable by means of the program control device 19. By this means, it is possible to allow water held in the reservoir 14 to flow into the wash cavity 2 depending on the selected wash program.

Arranged in the pump housing 16 of the wash cavity 2 is the circulation pump 22 which, in this embodiment also comprises an electrical heating device. Said pump is connected to a spray system 23 arranged in the interior of the wash cavity 2. It is thus possible to spray wash items arranged within the wash cavity 2 with water during a wash cycle, in order to clean said wash items. Also arranged in the pump housing is a drain pump 24 which enables water that is no longer needed to be pumped out. With the circulation pump 22—provided a heating device is present—both the heating function and the pumping function are individually controllable by the program control device 19. The program control device 19 is also connected to the drain pump 24 for the control thereof. The heating device serves, in particular, to bring the water to a desired minimum temperature for the respective program step if the prevailing temperature of the water fed in is below the respectively required minimum temperature. Said heating device can be provided in addition to, or independently of, the circulation pump at another suitable site of the liquid circulation system of the dishwasher.

The feeding of the reservoir 14 with water is undertaken, like the control of the outlet valve 20, the circulation pump 22, a heating device that may be present, and the drain pump 24 and other devices of the dishwasher 1 not described herein, depending on a selected wash program stored in the program control device 19. In the exemplary embodiment of the present dishwasher 1, at least one wash program is provided that is selectable specifically for the efficient use of hot water from the hot water supply WH and of cold water from the cold water supply KH.

FIG. 3 shows a function diagram to explain the function of the dishwasher 1 of FIGS. 1 and 2. The sequence of a wash program SP which is provided to control the sequence of a wash cycle such that efficient use is made of hot water from the hot water supply WH and of cold water from the cold water supply KH is illustrated.

In FIG. 3, the graphs SWV, SKV, SAV and BVB which illustrate switching and operating states of components of the dishwasher 1 on the vertical axis Z, are placed over a common time axis t.

The curve SWV represents the switching state of the hot water valve 6 of the dishwasher 1. The curve SKV also shows the switching state of the cold water valve 8 of the dishwasher 1. The curve SAV on the other hand shows the switching state of the outlet valve 20. The switching state “0” corresponds in each case to a closed valve 6, 8, 20 and the switching state “1” represents an opened valve 6, 8, 20. Finally, the curve BVB shows the filling state of the reservoir 14 with water. A reservoir 14 filled with hot water from the hot water supply WH is identified as “WW”, a reservoir 14 filled with cold water from the cold water supply KH is represented as “KW” and an empty reservoir 14 is represented as “0”.

In FIG. 3 a wash program SP is illustrated, by way of example comprising, in the following sequence, a pre-wash step VS, a cleaning step RS, an intermediate rinsing step ZS, a final rinsing step KS and a drying step TS. In other examples, one or more of these steps can be switched off or left out. Examples are also possible in which one or more steps are performed multiple times.

The pre-wash step VS performed first serves to remove the coarsest soiling from the wash items in order to prepare for the cleaning step RS. At the start of the pre-wash step VS, the reservoir 14 is full of cold water from the cold water supply KH which was used during the performance of a drying step TS to cool the wash cavity 2 in a wash cycle performed earlier. The storage of the cold water from the previous wash cycle reduces the water consumption of the dishwasher. In addition, the stored cold water in the reservoir is at substantially ambient temperature which is usually higher than the temperature at which the cold water is drawn from the cold water supply. At the start of the pre-wash step VS, this cold water is fed, by temporary opening of the outlet valve 20, into the wash cavity 2 and is circulated by the circulation pump 22 for a pre-determined time, in order to apply cold water to the wash items.

If heating of the water during the pre-wash step is not provided for, the pre-heating of the cold water to room temperature leads directly to a higher pre-wash temperature, which increases the cleaning effect without further energy input. However, if heating of the cold water during the pre-wash step is provided, for example, by means of a heating device in the circulation pump 22, to a pre-determined minimum temperature, the energy required to reach the pre-determined temperature falls. Therefore, in both cases, the efficiency of the dishwasher 1 is improved compared with a dishwasher wherein cold water is drawn from the cold water supply KH immediately before or during the pre-wash step VS. Compared with a dishwasher in which hot water is drawn from the hot water supply WH for the pre-wash step VS, the quantity of heat taken from the hot water supply WH can also be reduced.

During the pre-wash step VS, the hot water valve 6 is temporarily opened in order to fill the previously emptied reservoir 14 with hot water from the hot water supply WH. If, during the pre-wash step VS, the temperature of the water in the wash cavity 2 is higher than the temperature of the hot water supply, due, for example, to heating by means of the heating device of the circulation pump 22, then at least part of the heat energy of the water available in the wash cavity 2 can be reclaimed by heat transfer to the reservoir 14 before the now dirty water is pumped out (in a manner not shown) by means of the drain pump 24.

The cleaning step RS carried out subsequently serves for thorough cleaning of the wash items. At the start of the cleaning step RS, the reservoir 14 is filled with hot water from the hot water supply WH, as stated. At this time point, the outlet valve 20 is temporarily opened to fill the wash cavity 2 with this hot water from the hot water supply WH. The hot water fed into the wash cavity 2 is now circulated with the aid of the heating pump 22 for a pre-determined time in order to apply hot water to the wash items. The heating device of the heating pump 22 can be switched on as needed, depending on the temperature of the hot water fed in and depending on the intended wash temperature of the cleaning step RS. Similarly, during the cleaning step RS, the reservoir 14 is filled again, by temporary opening of the hot water valve 6, with hot water from the hot water supply WH, which can be further heated if the temperature in the wash cavity 2 is sufficient. At the end of the cleaning step RS, the now dirty hot water is pumped out (in a manner not shown) by the drain pump 24.

During the cleaning step RS, it is normally required to apply to the wash items water that has a relatively high temperature in order to achieve a high thermal cleaning effect. In addition, a cleaning agent is usually added to the water, the chemical effect of which is best at raised temperatures. Normally, therefore a temperature in the range of approximately 50° C. to 70° C. is provided for a cleaning step RS. When hot water from the hot water supply WH is used for the cleaning step RS, it is therefore ensured that the heat energy drawn from the hot water supply WH is usefully employed. Precisely in this way, a large saving of electrical energy can be achieved since, in many cases, the hot water from the hot water supply WH does not need to be further heated by the electrical heating pump 22 of the dishwasher 1 and, in other cases, only slightly, in order to achieve the required minimum temperature.

The intermediate rinsing step ZS now performed for removing cleaning agent from the wash items following the wash step RS takes place using hot water from the hot water supply WH which was fed into the reservoir 14 during the cleaning step RS. For this purpose, initially the outlet valve 20 is opened again briefly to feed hot water into the wash cavity 2. This hot water is circulated by the circulation pump 22 for a predetermined time, wherein normally the heating device thereof does not need to be switched on. The now dirty hot water is then pumped out by the drain pump 24.

Alternatively, during the intermediate rinsing step ZS, cold water from the cold water supply KH can be used entirely or partially. This would lead to an energy saving, although the intermediate rinsing time would normally have to be prolonged to achieve a pre-determined cleaning effect.

During the intermediate rinsing step ZS, the hot water valve is also temporarily opened in order to supply the reservoir 14 again with hot water from the hot water supply WH. Said hot water is then available during the subsequent final rinsing step KS for applying to the wash items, wherein the outlet valve 20 is again opened briefly in order to feed water to the wash cavity 2. The hot water fed into the wash cavity 2 is now circulated with the aid of the heating pump 22 for a pre-determined time in order to apply hot water to the wash items. During the final rinsing step KS, also, the heating device of the circulation pump 22 can be switched on depending on the temperature of the hot water fed in and depending on the intended wash temperature, as needed. At the end of the final rinsing step KS, the now dirty hot water is pumped out by means of the drain pump 24.

A subsequent final rinsing step KS serves, in particular, to prevent flecks which can form on the wash items due to dissolved substances in the water, such as salt and/or lime. For this purpose, a rinse aid is added to the water during the final rinsing step KS. A further purpose of the final rinsing step KS is to prepare for the subsequent drying step TS. During the final rinsing step KS, the wash items are heated in that particularly hot water at a temperature in the range, for example, of 60° C. to 75° C. is used. By this means, during the subsequent drying step TS, water drops adhering to the wash items evaporate and condense on the inside of the wash cavity 2 due to the lower temperature prevailing there. When hot water from the hot water supply WH is used for the final rinsing step KS, it is also ensured that the heat energy drawn from the hot water supply WH is usefully utilized. In this case, also, a large saving of electrical energy can be achieved since the hot water from the hot water supply WH does not need, in many cases, further heating with the electrical heating device 22 of the dishwasher 1 or, in other cases, only slightly, in order to achieve the minimum temperature required for the final rinsing step KS.

The drying step TS which concludes the wash program SP serves to dry the wash items situated in the wash cavity 2 which have been cleaned. The temperature of the wash items is relatively high at the start of the drying step due to the preceding final rinsing step, so that water adhering to the wash items evaporates. At the same time, the walls of the wash cavity 2 are cooled by giving up the heat thereof to the outside. By this means, a temperature differential is produced between the wash items in the wash cavity 2 and the inside of the walls of the wash cavity 2, so that the evaporated water condenses on the walls. The more water that condenses out, the more that further evaporation is encouraged.

In order to promote the condensation process, the reservoir 14 is filled with cold water following completion of the final rinsing step KS, at the start and/or during the drying step TS, by opening the cold water valve 8. This further reduces the temperature of the side wall 15. After filling the reservoir 14, the cold water valve 8 is closed again. At a time point pre-determined by the wash program, the drying step TS and the wash program SP are ended altogether, the cold water remaining in the reservoir 14 and being held there for a later wash cycle. Due to the cooling of the wash cavity 2 by the cold water in the reservoir 14, a superb drying result can be achieved in a short time, so that good drying efficiency results.

In an advantageous exemplary embodiment, the invention concerns heat-exchanger technology using at least one reservoir which is in heat-conducting contact with the wash cavity of a dishwasher. The dishwasher is equipped with a hot water connection, in particular, a hot water solar heating connection and a cold water connection, i.e. said dishwasher has a bithermal water connection. In a suitable exemplary embodiment of a dishwasher according to the invention, preferably two water connections—a hot water connection and a cold water connection—are provided, each separately controllable with a valve, particularly an Aquastop valve. In particular, a first water connection for hot, economical solar heated water and a second water connection for cold water from the mains supply are provided. Both water connections can be individually selected via a control system of the dishwasher.

The dishwasher is equipped with the heat-exchanger technology, special programs for this purpose being stored in the control unit. If the customer selects a special function, the machine can specifically react thereto. All the programs are adjusted so that the machine reacts appropriately to the hot water connection, particularly the solar hot water connection and the cold water connection from the mains network.

A wash program can be provided, in particular, wherein for cleaning, for intermediate rinsing and for final rinsing, hot water, which was previously placed in the reservoir and comes from a solar installation, is drawn therefrom. In the case of this wash program, for a drying procedure, the reservoir is again filled with cold water from a cold water supply in order to enable a sufficiently cold condensation surface to form. Said cold water is drawn from the reservoir for a pre-wash step of a subsequent wash cycle.

The use of cold water for producing a condensation surface causes the drying performance to remain at a high level despite the hot water connection, particularly the hot water connection to a solar hot water connection. This results in an energy-saving program sequence with a very good drying performance.

### REFERENCE SIGNS

1 Dishwasher
2 Wash cavity
3 Door
4 Housing
5 Water inlet device
6 Hot water valve
7 Hot water hose
8 Cold water valve
9 Cold water hose
10 Linkage member
11 Inlet hose
12 Connection member fastened to housing
13 Free flow path
14 Reservoir, Heat exchanger
15 Side wall
16 Pump housing
17 Waste connection member
18 Waste hose
19 Program control device
20 Outlet valve of reservoir
21 Outlet
22 Circulation pump
23 Spraying device
24 Drain pump, waste pump
A Waste pipe
KH Cold water supply, cold water tap
WH Hot water supply, hot water tap
SWV Switching state of the hot water valve
SKV Switching state of the cold water valve
SAV Switching state of the outlet valve
BVB Fill level of reservoir
SP Wash program
VS Pre-wash step
RS Cleaning step
ZS Intermediate rinsing step
KS Final rinsing step
TS Drying step

1-19. (canceled)

20. A dishwasher, comprising:
a wash cavity for accommodating wash items;
a water inlet device having a hot water inlet configured for intake of hot water from an external hot water supply, and a cold water inlet configured for intake of cold water from an external cold water supply;
at least one reservoir which is in communication with the water inlet device for allowing water to be filled by the water inlet device and which is in heat-conducting contact with the wash cavity; and
a program control device in which at least one wash program for controlling at least one wash cycle for cleaning wash items is stored, said wash program providing at least one program step for washing wash items using hot water from the hot water supply and at least one drying step for drying wash items,
wherein the reservoir is filled at least at times with cold water from the cold water supply.

21. The dishwasher of claim 20, constructed in the form of a domestic dishwasher.

22. The dishwasher of claim 20, wherein the wash program provides a cleaning step for washing wash items, with hot water from the hot water supply being applied to the wash items.

23. The dishwasher of claim 20, wherein the wash program provides a final rinsing step for rinsing the wash items, with hot water from the hot water supply being applied to the wash items.

24. The dishwasher of claim 20, wherein the wash program provides an intermediate rinsing step for cleaning wash items, with hot water from the hot water supply being applied to the wash items.

25. The dishwasher of claim 20, wherein the wash program provides at least one program step for washing wash items, with cold water from the cold water supply, with which the reservoir was filled during the drying step of a previous wash cycle, being applied to the wash items.

26. The dishwasher of claim 25, wherein the at least one program step is a pre-wash step and/or a cleaning step.

27. The dishwasher of claim 20, wherein the wash program provides at least one program step for washing wash items, with hot water from the hot water supply, with which the reservoir was filled during a previous program step of a same wash cycle, being applied to the wash items.

28. The dishwasher of claim 27, wherein the at least one program step is a cleaning step, an intermediate rinsing step and/or a final rinsing step.

29. The dishwasher of claim 20, wherein the wash program provides for filling of the reservoir with cold water from the cold water supply.

30. The dishwasher of claim 29, wherein the reservoir is filled with cold water from the cold water supply after ending a final rinsing step at start of and/or during the drying step of a respectively running wash program.

31. The dishwasher of claim 20, wherein the program control device is configured to adapt the wash program in the absence of a connection between the hot water inlet and a hot water supply and/or a connection between the cold water inlet and a cold water supply.

32. The dishwasher of claim 20, wherein the reservoir lies flat against the wash cavity.

33. The dishwasher of claim 20, wherein the reservoir is a plastics part.

34. The dishwasher of claim 33, wherein the plastic part is made from polypropylene.

35. The dishwasher of claim 20, wherein the reservoir is arranged at a side wall, base wall, top wall and/or rear wall of the wash cavity.

36. The dishwasher of claim 20, further comprising an insulating layer between the reservoir and the wash cavity.

37. The dishwasher of claim 36, wherein the insulating layer is a heat insulating and/or sound insulating insulation layer.

38. The dishwasher of claim 36, wherein the insulating layer is a bitumen layer.

39. The dishwasher of claim 20, wherein the reservoir is arranged at an upper section of the wash cavity.

40. The dishwasher of claim 20, wherein a free flow path is assigned to the hot water inlet device and/or the cold water inlet device.

41. The dishwasher of claim 20, wherein the hot water inlet comprises a hot water valve, and the cold water inlet comprises a cold water valve, said program control device being constructed to control the hot water valve and the cold water valve independently of one another.

42. The dishwasher of claim 41, wherein the hot water valve is arranged and configured at an upstream end of a hot water hose such that the hot water valve is securable to a connection member of the external hot water supply, and/or the cold water valve is arranged and configured at an upstream end of a cold water hose such that the cold water valve is securable to a connection member of the external cold water supply.

43. The dishwasher of claim 42, further comprising a housing, wherein a downstream end of the hot water hose and a downstream end of the cold water hose are linked via a linkage member in fluid conducting manner to a connection member fixed to the housing.

44. The dishwasher of claim 43, wherein the downstream end of the hot water hose and the downstream end of the cold water hose are linked to the connection member via an outlet-side common inlet hose,

45. The dishwasher of claim 20, wherein the hot water supply is provided by a solar thermal installation.

46. A method for controlling at least one wash cycle of a dishwasher, comprising:
executing a wash program of a program control device for washing wash items accommodated in a wash cavity such that in one program step hot water is fed from an external hot water supply by a hot water inlet;
executing in another program step at least one drying step for drying the wash items; and
at least temporarily filling during the drying step a reservoir in heat-conducting contact with the wash cavity with cold water from an external cold water supply via a cold water inlet.

47. The method of claim 46 for controlling at least one wash cycle of a domestic dishwasher.
